(19) United States
(12) Patent Application Publication
(10) Pub. No.: US 2009/0022242 A1
(43) Pub. Date: Jan. 22, 2009

(54) SYSTEMS AND METHODS FOR INCREASED DATA RATE MODES USING MULTIPLE ENCODERS/DECODERS

(75) Inventors: Deric W. WATERS, Dallas, TX (US); Anuj Batra, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/130,449

(22) Filed: May 30, 2008

Related U.S. Application Data
(60) Provisional application No. 60/950,396, filed on Jul. 18, 2007.

(51) Int. Cl. H04L 27/00

(52) U.S. Cl. 375/299; 375/340

(57) ABSTRACT

Systems and methods for providing for increased data rate modes using multiple encoders and decoders, comprising a transmitter comprising multiple encoders, wherein at least one of the encoders has a different error protection strength than at least one other of the encoders. Some embodiments comprise multiple encoders, wherein a symbol receives bits produced by at least two of the multiple encoders. Other embodiments comprise multiple encoders connected to at least one interleaver. Still other embodiments comprise a plurality of decoders, the decoders decoding received bits mapped on symbols on received tones, the bits received from at least one transmitter comprising a plurality of encoders and at least one interleaver.

### CROSS-REFERENCE TO RELATED APPLICATIONS

The present application claims priority to U.S. provisional patent application Ser. No. 60/950,396, filed Jul. 18, 2007, and entitled “Multiple Encoders/Decoders to Enable Higher Data Rate Modes of WiMedia PHY and Methods Using Same”, hereby incorporated in its entirety herein by reference.

### BACKGROUND

As devices become increasingly mobile and interoperable, networks may be more than the customary established grouping of devices. Instead, or in some cases in addition, devices join and leave networks on an ad-hoc basis. Such devices may join an existing network, or may form a temporary network for a limited duration or for a limited purpose. An example of such networks might be a personal area network (PAN). A PAN is a network used for communication among computer devices (including mobile devices such as laptops, mobile telephones, game consoles, digital cameras, and personal digital assistants) which are proximately close to one person. Any of the devices may or may not belong to the person in question. The reach of a PAN is typically a few tens of meters. PANs can be used for communication among the personal devices themselves (ad-hoc communication), or for connecting to a higher level network and/or the Internet (infrastructure communication). Personal area networks may be wired, e.g., a universal serial bus (USB) and/or IEEE 1394 interface or wireless. The latter communicates via networking technologies consistent with the protocol standards propounded by the Infrared Data Association (IrDA), the Bluetooth Special Interest Group (Bluetooth), the WiMedia Alliance's ultra wideband (UWB), or the like.

Among recently emerging communication technologies—especially those needing high data transfer rates—various ultra-wideband (UWB) technologies are gaining support and acceptance. UWB technologies are utilized for wireless transmission of video, audio or other high bandwidth data between various devices. Generally, UWB is utilized for short-range radio communications—typically data relay between devices within approximately 10 meters—although longer-range applications may be developed. A conventional UWB transmitter generally operates over a very wide spectrum of frequencies, several GHz in bandwidth. UWB may be defined as radio technology that has either: 1) spectrum that occupies bandwidth greater than 20% of its center frequency; or, as is it is more commonly understood, 2) a bandwidth ≧500 MHz.

Next generation networks, such as those standardized by the WiMedia Alliance, Inc., increase the range, speed, and reliability of wireless data networks. One implementation of next generation networks utilizes ultra-wideband (UWB) wireless technology, specifically a MultiBand orthogonal frequency-division multiplexing (OFDM) physical layer (PHY) radio along with a sophisticated medium access control (MAC) layer that can deliver data rates up to 480 megabits per second (Mbps).

The WiMedia UWB common radio platform enables high-speed (up to 480 Mbps), low power consumption data transfers in a wireless personal area network (WPAN). The WiMedia UWB common radio platform incorporates MAC layer and PHY layer specifications based on MultiBand OFDM (MB-OFDM). WiMedia UWB is optimized for the personal computer (PC), consumer electronics (CE), mobile device and automotive market segments. ECMA-368 and ECMA-369 are international ISO-based specifications for the WiMedia UWB common radio platform. Additional information may be found in U.S. patent application Ser. No. 11/099,317, entitled “Versatile System for Dual Carrier Transformation in Orthogonal Frequency Division Multiplexing”, and U.S. patent application Ser. No. 11/551,980, entitled “Dual-Carrier Modulation Decoder”, which are incorporated herein by reference.

The WiMedia Alliance is in the process of developing a road map that will extend the physical data rates to 960 Mbps and beyond. The current WiMedia Alliance physical layer (versions 1.0-1.2) uses a single forward error correcting (FEC) encoder at the transmitter that yields a maximum data rate of 480 Mb/s. Implementing the FEC decoder in real-time already requires significant resources at the receiver—however, the complexity grows significantly if a single decoder is used to support higher data rates.

Increasing demand for more powerful and convenient data and information communication has resulted in a number of advancements, particularly in wireless communication technologies. Despite the advancements, however, significant improvement in data transfer rates is sought.

### BRIEF DESCRIPTION OF THE DRAWINGS

For a detailed description of exemplary embodiments of the invention, reference will be made to the accompanying drawings in which:

FIG. 1 illustrates a block diagram of an exemplary communication system, in which embodiments may be used to advantage;

FIG. 2 illustrates a block diagram of an exemplary transmitter in accordance with an embodiment;

FIG. 3 illustrates a block diagram of an exemplary transmitter in accordance with another embodiment;

FIG. 4 illustrates a block diagram of an exemplary transmitter in accordance with a further embodiment;

FIG. 5 illustrates a block diagram of an exemplary transmitter in accordance with yet a further embodiment;

FIG. 6 illustrates a block diagram of an exemplary transmitter in accordance with a still further embodiment;

FIG. 7 illustrates an exemplary general-purpose computer system suitable for implementing the several embodiments of the disclosure; and

FIG. 8 illustrates an exemplary MAC, PHY, and MAC-PHY interface suitable for implementing the several embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In light of the foregoing background, embodiments provide systems and methods for using multiple low-complexity encoders and/or decoders, which systems and methods are particularly useful for exploiting frequency diversity for data rates higher than 480 Mbps. Embodiments enable a transmitter to compose tones for transmission which support higher data rates using encoders of reasonable complexity. Embodiments using multiple encoders at the transmitter further enable a receiver to decompose the received tones using multiple FEC decoders, thereby enabling the receiver to support higher data rates with decoders of reasonable complexity. It should be appreciated that at least one benefit to embodiments lies in the fact that the complexity and cost required to implement a single encoder (or decoder, as the case may be) to support very high data rates is significantly greater than the complexity and cost of implementing multiple encoders (or decoders, as the case may be) each supporting lower data rates. It should also be appreciated that embodiments may be employed in multiple subcarrier communication systems in a parallel fashion, or in other communication systems in a serial fashion. It should further be appreciated that while embodiments may be discussed herein in connection with a single transmitter system, the scope of the embodiments and the appended claims should not be constrained because embodiments may alternatively be incorporated in other types of communication systems including, but not limited to multiple-input multiple-output communication systems, etc.

Although embodiments will be described for the sake of simplicity with respect to wireless communication systems, it should be appreciated that embodiments are not so limited, and can be employed in a variety of communication systems over a variety of physical mediums. It should also be appreciated that some embodiments employ at least one ultra-wideband transmitter, other embodiments employ at least one ultra-wideband receiver, while still other embodiments may employ both. It should be further appreciated that some embodiments are short-range—where short-range is up to approximately 20 meters; such embodiments may be high speed (UWB) or not, and may comprise or be a part of such communication systems as personal area networks, body area networks, etc.

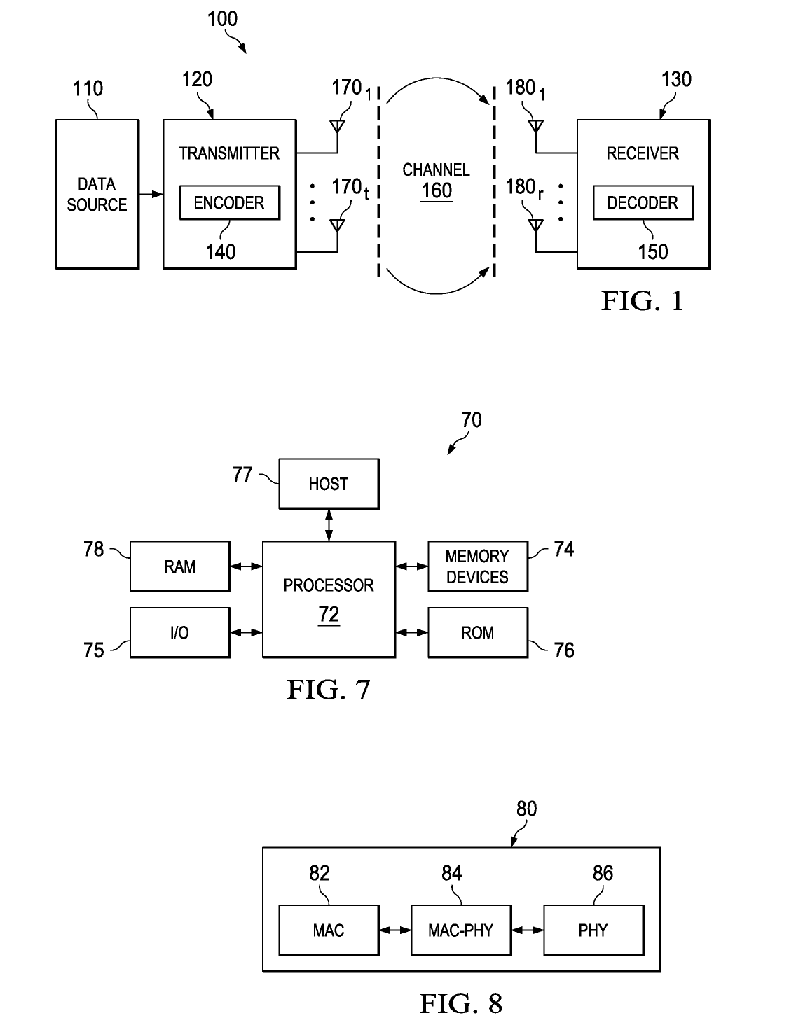

To better understand embodiments of this disclosure, consider exemplary communications system 100, illustrated in FIG. 1 and in which embodiments may be used to advantage. FIG. 1 is a block diagram of a communications system 100 comprising transmitter 120 and receiver 130. The input to transmitter 120 is the output of data source 10. Transmitter 120 comprises encoders 140, which are represented for ease of understanding at the level of this diagram as a single encoder block 140, but which actually comprises a plurality of encoders. Receiver 130 comprises decoders 150—similarly represented for ease of understanding at the level of this diagram as a single decoder block 150, but which block actually comprises one or more decoders, depending upon embodiment. It should be appreciated that either or both transmitter 120 and receiver 130 may comprise additional functional blocks for further processing (e.g., noise variance estimation, channel estimation, FEC decoder, synchronization, scaling of channel outputs, etc.). Symbols which have been mapped onto tones are broadcast via transmitting antennas 170₁-170ₜ from transmitter 120 across channel 160 to receiving antennas 180₁-180ᵣ of receiver 130, where t=the number of transmitting antennas and r=the number of receiving antennas. It should be appreciated that channel 160 is being considered as a generic channel for discussion purposes; the specific communication system in which it appears dictates its characteristics. For example in FIG. 1, it corresponds to a channel between transmitting and receiving antennas; however in other embodiments it may involve inverse fast-Fourier transformation, fast-Fourier transformation, etc.

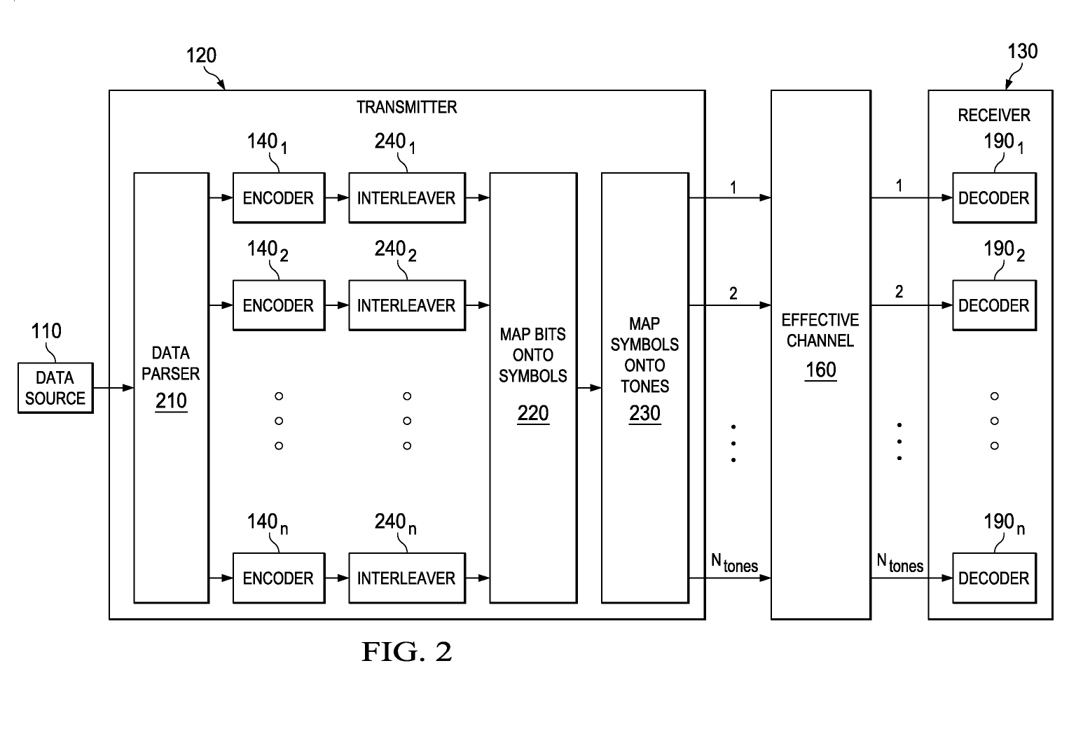

FIG. 2 illustrates a block diagram of an embodiment, showing some of the components which comprise transmitter 120; specifically, transmitter comprises data parser 210, encoders 140₁, 140₂, . . . , 140ₙ, interleavers 240₁, 240₂, . . . , 240ₙ, and mapping blocks 220 and 230 which map bits to symbols and map symbols to tones, respectively. Data is received from source data 110. It should be appreciated that although only one data source is illustrated, alternative embodiments may instead comprise multiple data sources. Parser 210 parses the received source data into N_{enc} independent FEC encoders (140₁, 140₂, . . . , 140ₙ), where N_{enc}=the number of encoders within transmitter 120. Each encoder 140 may employ a unique FEC code. An encoder, as understood and used herein, is a non-recursive or recursive code followed by a puncturer that may remove some of the parity bits after encoding with an error-correction code and/or a rate-matching mechanism that generates the desired code rate. The remaining encoded bits are fed to the respective interleavers 240₁, 240₂, . . . 240ₙ and are then sent to mapping block 220 to be mapped to symbols, i.e., mapping block 220 creates a constellation symbol for each of the Nₜₒₙₑₛ subcarriers in the system. It should be noted that in some embodiments, interleavers may include multiple stages such as those discussed in U.S. patent application Ser. No. 10/797,880 for “Efficient Bit Interleaver for a Multi-band OFDM Ultra-wideband System” and in U.S. patent application Ser. No. 11/939,222 for “Efficient Bit Interleaver for A Multi-Band OFDM Ultra-Wideband System”, incorporated herein in their entirety by reference. The constellation may be a conventional alphabet such as QAM or PSK, or it may be generated by dual-carrier modulation (DCM); for further discussion of dual-carrier modulation, see for example U.S. patent application Ser. No. 11/099,317 for “Versatile System for Dual Carrier Transformation in Orthogonal Frequency Division Multiplexing”, incorporated herein in its entirety by reference. The constellation symbols for each subcarrier are mapped onto tones at mapping block 230, after which they enter into effective channel 160. In some cases, signal shaping may be implemented on the tones before they are delivered into effective channel 160, for example as described in U.S. patent application Ser. No. 11/109,334 for “Versatile System for Signal Shaping in Ultra-Wideband Communications”, incorporated herein in its entirety by reference In addition to the transmission medium, in some embodiments, effective channel 160 comprises additional OFDM transmitter functions such as an inverse fast-Fourier transformer (FFT), adding a cyclic prefix or zero-padded suffix, etc. Embodiments of effective channel 160 may further, or alternatively, comprise additional functions of an OFDM receiver such as an inverse fast-Fourier transformer (IFFT), and cyclic prefix removal or an overlap and add function, etc. Receiver 130 receives a noisy version of the constellation symbols/tones at the output of effective channel 160. Receiver 130 uses its observations of the input constellation symbols to compute a log-likelihood ratio (LLR) for each coded bit output by the set of FEC encoders 140₁, 140₂, . . . , 140ₙ. Receiver 130 reverses the symbol-to-tone mappings, the bit-to-symbol mappings, and the interleaving, in addition to implementing FEC decoders 190₁, 190₂, . . . , 190ₙ, to recover the source data bits. In some embodiments, these FEC decoders are implemented in parallel; in other embodiments, the FEC decoders are sequentially implemented to enable hardware reuse; in still other embodiments, a hybrid implementation may comprise parallel decoders that share some building blocks such as multipliers, Add-Select-Compare, memory, etc. In some embodiments, there is the same number of decoders in receiver 130 as there are encoders in transmitter 120. The outputs of the FEC decoders are sent to a data sink which reverses the parsing operation performed at the data source. Embodiments employing multiple data decoders enable the decoders to operate at a slower rate. For example, if two encoders operating at 480 Mbps are used at transmitter 120 so that the overall data rate is 960 Mbps, then receiver 130 may implement two decoders that each operate at a rate of 480 Mbps. In general, implementing two 480 Mbps decoders or encoders—depending upon whether a receiver or a transmitter—is easier than implementing a single decoder or encoder, respectively, operating at 960 Mbps.

While the generic system blocks may be implemented in many different ways, transmitter 120 and receiver 130 preferably agree beforehand about how transmitter 120 generates the symbols on each subcarrier from the data bits it will send to receiver 130. Embodiments of transmitter 120 and receiver 130 agree on, for example, how the data parser will parse the data bits into the encoder(s), the number of encoders used, the type of encoders used, how the constellation symbols will be generated from the encoded bits, how the constellation symbols will be mapped to tones in the OFDM symbol, how the data source feeds the data bits into the parser, etc.

It should be expressly understood that each of the blocks in the system diagram may be implemented in a multitude of ways, and any combination of these different implementations creates a new embodiment. For example, and without limitation, embodiments of individual system blocks may be implemented as follows:

Data Parsing. Parsing data into multiple encoders 140 within a single transmitter 120 can be done in any number of ways. For example, parser 210 could deliver g₁ bits to the first encoder, 140₁, the next g₂ bits to the second encoder, 140₂, and so forth until it assigns g_{Nenc} bits to the last encoder, 140ₙ, where N_{enc}=number of encoders in transmitter 120. If more data bits remain, then the parser loops back and delivers more bits to each encoder until there are no more data bits to deliver. Some examples of parser 210 using this notation include, without limitation:

1. If N_{enc}=2 and g₁=g₂=1, then parser 210 sends every other bit to the same encoder. Alternatively, if g₁=g₂=2, then parser 210 sends every other pair of bits to the same encoder, etc.

2. If N_{enc}=2, there are D total data bits, and g₁=g₂=D/2, then parser 210 assigns the first D/2 bits to the first encoder and the last D/2 bits to the second encoder.

3. Regardless of the number of encoders, some embodiments may comprise encoders that have different coding rates; as a result, parser 210 would send an appropriate—albeit different—number of data bits to create the same length codeword. This is an example of when gᵢ≠gⱼ.

4. If there are D total data bits, in some embodiments, parser 210 would assign D/N_{enc} bits to each encoder with gᵢ=D/N_{enc}.

5. It should be appreciated that in some embodiments parser 210 would assign different numbers of bits to different encoders thereby producing code words of different lengths.

Encoding. Encoders 140₁, 140₂, . . . , 140ₙ may be defined in a multitude of ways, some examples are given below. It is possible to use different encoders to provide different amounts of error protection for the resulting code words. Example encoder embodiments, without limitation, include:

1. All encoders 140₁, 140₂, . . . , 140ₙ use the same code, with the same coding rate and puncturing pattern. Such encoders would preferably also use the same constraint lengths, if applicable.

2. All encoders 140₁, 140₂, . . . , 140ₙ use the same code, but one or more of them have different puncturing rates and/or puncturing patterns. Varying the puncturing rates and/or puncturing patterns enables the encoders to have different coding rates even if the encoders are built from the same underlying code. Alternatively, a rate-matching mechanism may be used to achieve the desired code rate instead of puncturing.

3. Each encoder 140₁, 140₂, . . . , 140ₙ is unique. Convolutional codes may be unique because they use different constraint lengths, or different generator polynomials, or both. The encoders may be unique in that one or more of the encoders use entirely different codes from at least one other encoder in transmitter 120. Examples of the types and variety of codes encoders 140₁, 140₂, . . . , 140ₙ may use include codes such as a convolutional code, a Reed-Solomon code (or other type of error-correcting code that oversamples a polynomial constructed from the incoming data), a low-density parity-check (LDPC) code, a turbo code or other types of error correction codes, including for an example, and not by way of limitation, any high-performance error correction code.

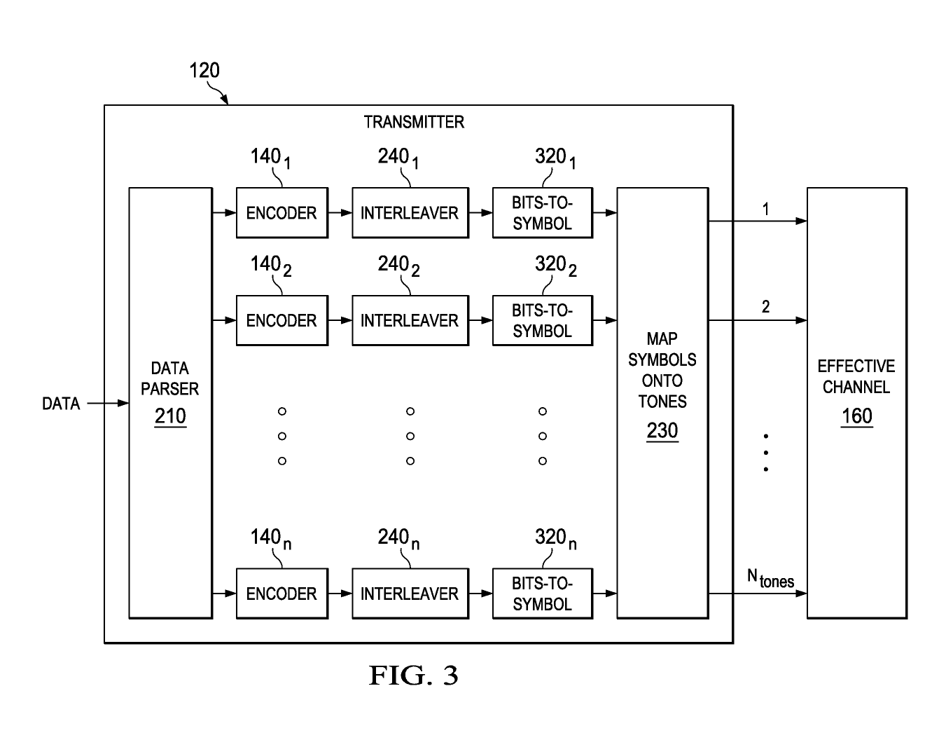

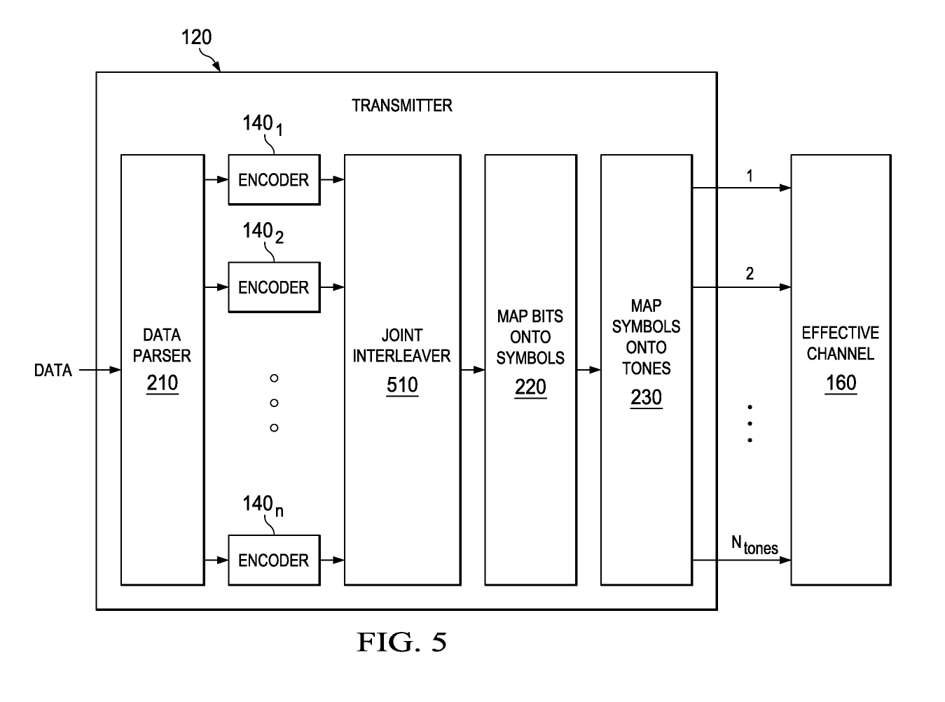

Interleaving. Interleaving is important to improved communication systems. The frequency response of a channel is not always constant. As a result, the probability of error varies across different subcarriers. This phenomenon is known as frequency diversity. Although the channel may not have access to the channel response, it can spread the frequency diversity across the codeword(s) to avoid groups of neighboring symbols all having high probabilities of error and also to avoid transmitting consecutive bits on the least significant bits of multiple consecutive (in frequency) symbols. In FIGS. 2 and 3, for example and not by way of limitation, this interleaving is accomplished by individually interleaving the encoder outputs. Alternatively in FIG. 5, for example and not by way of limitation, this interleaving is accomplished by jointly interleaving the encoder outputs; it should be appreciated that this joint interleaver could be a part of the bits-to-symbols mapping functional blocks 220 where it may interleave symbols rather than bits. Alternatively, in some embodiments, the number of interleavers is not equal to the number of encoders. For example, and not by way of limitation, in some embodiments the outputs of some encoders are jointly interleaved while the outputs of other encoders are individually interleaved. The interleaving may also cover multiple OFDM symbols to exploit time diversity in the same way interleaving can exploit frequency diversity. It should be understood that within the interleaver block there may be multiple stages of interleaving. It should be readily understood that interleaving from multiple encoders within a single transmitter 120 can be accomplished in multiple ways, including, for example and without limitation:

1. The bits from all the encoders are interleaved into a single bit stream before being mapped onto symbols.

2. The bits from some or all encoders may be interleaved separately from the bits of other encoders before bits are mapped onto symbols.

3. The interleavers may rearrange the order of the encoded bits such that adjacent encoded bits are transmitted in different OFDM symbols.

Mapping bits to symbols. The bit-to-symbol mapping also impacts the probability of error for the bits. The mapping from multiple encoders can be exploited to control the error protection of different bits. Some examples of ways to map bits to symbols in a constellation are given below.

1. In general, the more symbols contained in a constellation, the higher the probability of bit error for that constellation. For example, a 64-QAM constellation has a higher average bit error probability than a 16-QAM constellation which in turn has a higher average bit error probability than a 4-QAM constellation. Therefore, using separate constellations for the bits from each encoder, such as would occur in embodiments where there are bits-to-symbol mapping functional blocks corresponding to each encoder—such as that shown in FIG. 3 with or without the illustrated interleaver blocks 240—provides one way to manipulate the bit error probability. This is an example of an embodiment in which the outputs of the encoders may contain different numbers of bits.

2. In some bit mapping schemes, certain bits have a higher probability of error than others. For example, in the Gray mapped 16-QAM constellation there are two levels of bit protection: High and Low. Preferably, the most-significant bit (MSB) has high protection, and the least-significant bit (LSB) has low protection. In the Gray mapped 64-QAM constellation there are three levels of bit protection: High, Medium and Low. For Gray mapped QPSK, each bit has the same level of bit protection. Therefore, bits from different encoders may be given different amounts of error protection by assigning them to different bit indices (with different amounts of error protection) when generating constellation symbols.

3. In some embodiments, all of the bits are mapped onto the same constellation.

Mapping symbols to tones. Another way to exploit frequency diversity is to interleave the symbols before assigning them to subcarriers. The symbols can be assigned to subcarriers in any number of ways, such as for example, and not by way of limitation:

1. Some embodiments divide the subcarriers into Nₜₒₙₑₛ/N_{enc} groups of adjacent subcarriers each containing N_{enc} subcarriers. One symbol from each encoder's symbol stream is assigned to one of the subcarriers in each group.

2. An alternate way to exploit frequency diversity is to interleave the time-domain symbols across time. The time-domain interleaving can be done in any number of ways, such as but not limited to mapping a first constellation symbol to a first OFDM symbol, second constellation symbol to a second OFDM symbol, . . . , a sixth constellation symbol to a sixth OFDM symbol, a seventh constellation symbol to the first OFDM symbol, etc. It is expressly understood that there are several ways to implement such embodiments, this being only one example.

In a special case, the same information is transmitted in two consecutive symbols, for example in the case of time-domain spreading (as defined in WiMedia 1.0-1.2 specification). In this case, frequency diversity can be exploited by introducing a cyclic shift in the second symbol with respect to the first symbol. For example, and not by way of limitation, one implementation embodiment transmits a first time-domain symbol as is, but cyclically shifting a second time-domain symbol by N samples, where N is chosen to provide a better separation in terms of distance.

Any combination of the above embodiments of the individual system blocks yields a new embodiment of the overall system. Some further examples of systems demonstrating modularity include, but are not limited to:

1. The data parser sends each encoder the same number of bits (data parsing embodiment 4, above). The encoders use the same type of code, the same coding rate, and the same constraint lengths so that they provide the same amount of error protection to their encoded bits (encoding embodiment 1, above). The bits output to each encoder are interleaved separately from the bits of other encoders, then the encoders' bit streams are individually mapped onto symbols from the same constellation (interleaving embodiment 2 and mapping bits-to-symbols embodiment 3, above). The symbols coming from each encoder bit stream are spread across the OFDM symbol (mapping symbols to tones using either embodiment 1 or 2, above).

2. The transmitter can use different types of encoders and balance the amount of error protection by adjusting the constellations used to map the codeword bits onto symbols. This may be useful to achieve a higher overall data rate than a system using identical encoders. An exemplary embodiment individually interleaves (interleaving embodiment 2, above) bits output by each encoder, and then maps the resulting bits onto different symbol constellations (mapping bits-to-symbols embodiment 1, above). The data parser delivers bits to the encoders such that the kth encoder's bit stream results in Sₖ constellation symbols, where Sₖ may or may not be equal to Sⱼ (data parsing embodiment 5, above). The encoders have different constraint lengths (encoding embodiment 3, above). The symbols that come from encoders with longer constraint lengths use larger constellations (mapping bits-to-symbols using either embodiment 1, 2, or 3, above). The symbols coming from each encoder bit stream are spread across the OFDM symbol (mapping symbols to tones using either embodiment 1 or 2, above). This embodiment is also described by FIG. 3.

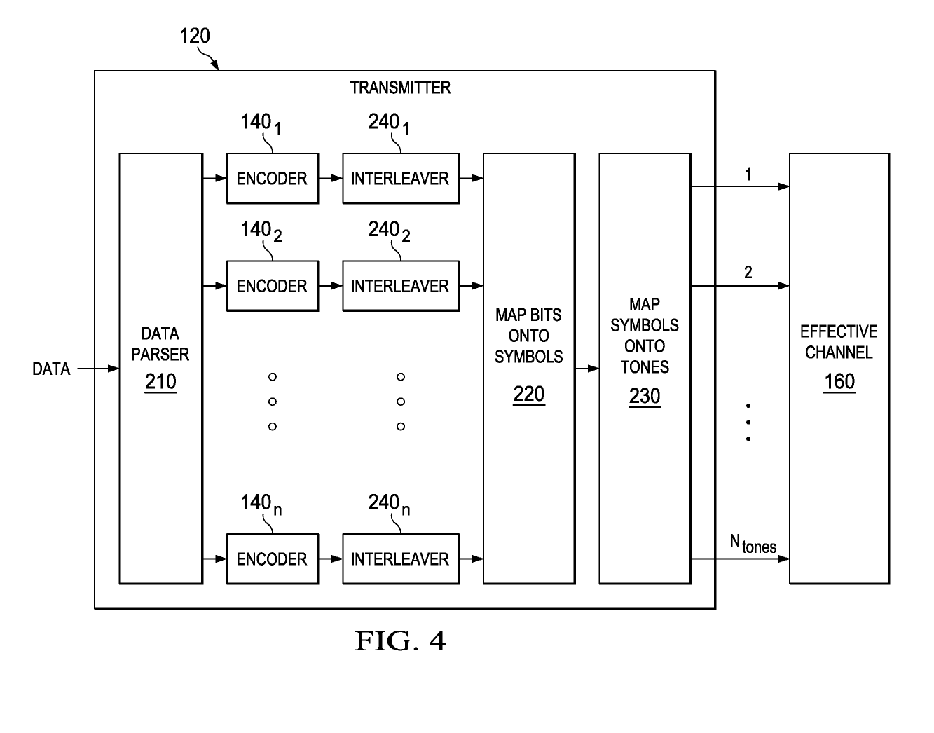

FIGS. 4, 5 and 6 illustrate other example embodiments of communication system architectures, and demonstrate the implementation versatility of present embodiments. It should be appreciated that many other variations are possible; these figures simply demonstrate a few of the possible embodiments. For example, in FIG. 4, data parser 210 delivers bits to encoders 140₁-140ₙ, which in turn pass the encoded bit streams to respective interleavers 240₁-240ₙ before providing the interleaved bits to block 220 (map bits onto symbols). As was the case with exemplary embodiment illustrated in FIG. 3, “map bits onto symbols” block 220 delivers the symbols to “map symbols onto tones” block 230 which in turn produces Nₜₒₙₑₛ outputs to effective channel 160. As a different example, FIG. 5 illustrates data parser 210 delivering bits to 140₁-140ₙ, which in turn pass the encoded bit stream to joint interleaver 510. Single joint interleaver 510 accepts the encoded bit stream from all of the encoders to interleave and provides the interleaved stream to “map bits onto symbols” block 220. The symbols are delivered to “map symbols onto tones” block 230 before transmitter 120 produces Nₜₒₙₑₛ outputs to effective channel 160.

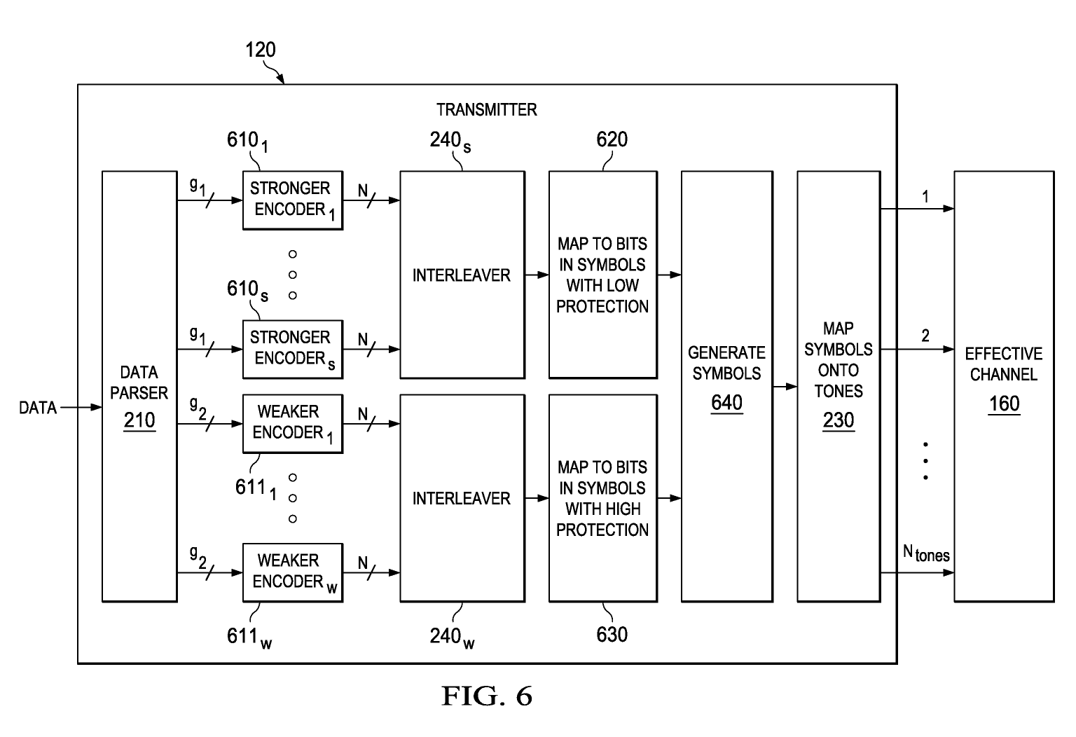

Alternatively, instead of having relatively equivalent encoders, some embodiments may instead have stronger and weaker encoders, where stronger encoders give more error protection (also referred to as error protection strength) than weaker encoders. For example, two convolutional encoders using the same generator polynomial with different puncturing rates provide different error protection; in this case the stronger encoder has less puncturing and a lower code rate. FIG. 6 illustrates one such exemplary embodiment in which encoders of differing capabilities are employed. Although there are two stronger encoders and two weaker encoders illustrated, it should be appreciated that more or less of each type of encoder may be employed in various embodiments. In the example illustrated in FIG. 6, each of the stronger encoders 610₁-610ₛ, where s is the number of stronger encoders, receives g₁ bits from data source and passes N encoded bits to a corresponding interleaver 240ₛ before forwarding the interleaved bits to block 620 where those bits are mapped to low and/or medium protected bits in symbols. Similarly, each of the weaker encoders 611₁-611_{w}, where w is the number of weaker encoders, receives g₂ bits from data parser 210 and passes N encoded bits to a corresponding interleaver 240_{w} before forwarding the interleaved bits to block 630 where those bits are mapped to high and/or medium protected bits in symbols. Thus, in this example, the stronger encoders 610ₛ supply the least-protected bits in the symbols and the weaker encoders 611_{w} supply the most-protected bits in the symbols. This results in a transmission where the bits have more nearly the same amount of error protection. The relative strengths of the encoders can be tuned to achieve more nearly equal error protection of all bits, for example encoders may be tuned with their coding rate, with their constraint length, or by using different generator polynomials.

It is expressly understood that, in some embodiments, the number of bits received by each error protection strength type of encoder may not be equal among them, and that the error protection strength may even vary among the stronger encoders, or among the weaker encoders, or both. For example, and again referring to FIG. 6, stronger encoder 610₁ may be stronger (or weaker) than stronger encoder 610ₛ; similarly, weaker encoder 611₁ may be stronger (or weaker) than weaker encoder 611_{w}. Nevertheless, stronger encoders 610₁-610ₛ are stronger in their relative error protection strengths than weaker encoders 611₁-611_{w}. As another example, stronger encoder 610₁ may receive more bits from data parser 210 than stronger encoder 610ₛ, and in some embodiments may receive more bits than any other of the encoders—weaker or stronger. As a further example, stronger coder 610₁ and weaker encoder 611₁ may receive less bits from data parser 210 than stronger encoder 610ₛ and weaker encoder 610_{w}. The number of output bits from each encoder (N in FIG. 6) may also differ among encoders in some embodiments. Further permutations and combinations of encoders will be readily apparent to those skilled in the art after considering the teachings presented herein.

As discussed in connection with other embodiments above, it should be appreciated that the multiple encoders of the embodiment illustrated in FIG. 6 could alternatively pass their respective N encoded bits to a joint (or single) interleaver 240. After mapping, both blocks 620 and 630 pass their respective outputs to block 640 where the symbols are generated. The symbols are mapped onto tones (block 230) before transmitter 120 outputs Nₜₒₙₑₛ to effective channel 160.

In at least some embodiments, the processing at the receiver is primarily dictated by how the transmitter created and transmitted the information. For example, if two identical encoders were used to create the transmitted codewords, then two identical decoders may be used to recover the information bits. Or if two different encoders were used to create the transmitted codewords, then two different decoders that are preferably matched to the respective encoders are used. In such embodiments, each decoder could process a different number of bits if the encoders have different coding rates.

The systems and methods described above may be implemented on any general-purpose computer with sufficient processing power, memory resources, and network throughput capability to handle the necessary workload placed upon it. FIG. 7 illustrates an exemplary, general-purpose computer system suitable for implementing one or more embodiments of a system to respond to signals as disclosed herein. Computer system 70 includes processor 72 (which may be referred to as a central processor unit or CPU) that is in communication with memory devices including secondary storage 74, read only memory (ROM) 76, random access memory (RAM) 78, input/output (I/O) 75 devices, and host 77. The processor may be implemented as one or more CPU chips.

Secondary storage 74 typically comprises one or more disk drives or tape drives and is used for non-volatile storage of data and as an over-flow data storage device if RAM 78 is not large enough to hold all working data. Secondary storage 74 may be used to store programs that are loaded into RAM 78 when such programs are selected for execution. ROM 76 is a non-volatile memory device that typically has a small memory capacity relative to the larger memory capacity of secondary storage. RAM 78 is used to store volatile data and perhaps to store instructions. Access to both ROM 76 and RAM 78 is typically faster than to secondary storage 74.

I/O devices 75 may include printers, video monitors, liquid crystal displays (LCDs), touch screen displays, keyboards, keypads, switches, dials, mice, track balls, voice recognizers, card readers, paper tape readers, or other well-known input devices. Host 77 may interface to Ethernet cards, universal serial bus (USB), token ring cards, fiber distributed data interface (FDDI) cards, wireless local area network (WLAN) cards, and other well-known network devices. Host 77 may enable processor 72 to communicate with an Internet or one or more intranets. With such a network connection, it is contemplated that processor 72 might receive information from the network, or might output information to the network in the course of performing the above-described processes. Processor 72 executes instructions, codes, computer programs, and scripts which it accesses from a hard disk, floppy disk, optical disk (these various disk-based systems may all be considered secondary storage 74), ROM 76, RAM 78, or the host 77.

The systems and methods described above may be implemented on devices with a MAC and a PHY; some embodiments may be implemented using at least one application-specific integrated circuit (ASIC) and/or at least one field-programmable gate array (FPGA) circuit. FIG. 8 illustrates an exemplary system 80 containing a MAC 82, a MAC-PHY interface 84, and a PHY 86. MAC 82 is capable, in this embodiment, of communicating with PHY 86 through MAC-PHY interface 84. MAC-PHY interface 84 may be a controller, processor, direct electrical connection, or any other system or method, logical or otherwise, that facilitates communication between MAC 82 and PHY 86. It is expressly understood that MAC 82, MAC-PHY interface 84, and PHY 86 may be implemented on a single electrical device, such as an integrated controller, or through the use of multiple electrical devices. It is further contemplated that MAC 82, MAC-PHY interface 84, and PHY 86 may be implemented through firmware on an embedded processor, or otherwise through software on a general purpose CPU, or may be implemented as hardware through the use of dedicated components, or a combination of the above choices. Any implementation of a device consistent with this disclosure containing a MAC and a PHY may contain a MAC-PHY interface. It is therefore expressly contemplated that the disclosed systems and methods may be used with any device with a MAC and a PHY.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A communication system, comprising:
a short-range transmitter comprising a plurality of encoders connected to at least one interleaver.

2. The communication system of claim 1, further comprising a receiver comprising a plurality of decoders.

3. The communication system of claim 1, further comprising a receiver comprising a plurality of decoders for decoding bits from a symbol, wherein some of the bits are decoded by one of the plurality of decoders and more of the bits are decoded by another of the plurality of decoders.

4. The communication system of claim 1, wherein the transmitter comprises a data parser.

5. The communication system of claim 1, wherein at least one of the encoders has a different error protection strength than at least one other of the encoders.

6. The communication system of claim 1, wherein the transmitter comprises a plurality of bits-to-symbols mapping functional blocks.

7. The communication system of claim 6, wherein at least two of the plurality of bits-to-symbols mapping functional blocks map to different constellations.

8. The communication system of claim 1, wherein the system is a multiple-input multiple-output (MIMO) communication system.

9. The communication system of claim 1, wherein less than all of the encoders share a joint interleaver.

10. The communication system of claim 1, wherein the transmitter has a plurality of transmitting antennas.

11. The communication system of claim 1, wherein at least two encoders produce bits for a single symbol.

12. A communication system, comprising:
a transmitter comprising a plurality of encoders, wherein at least one of the encoders has a different error protection strength than at least one other of the encoders.

13. The communication system of claim 12, wherein the transmitter comprises a single interleaver which receives the outputs of the plurality of encoders.

14. The communication system of claim 12, wherein the plurality of encoders are connected to a plurality of interleavers.

15. The communication system of claim 12, wherein a symbol receives bits produced by at least two of the plurality of encoders.

16. The communication system of claim 12, further comprising a receiver comprising a plurality of decoders.

17. A communication system, comprising:
a transmitter comprising a plurality of encoders, wherein a symbol receives bits produced by at least two of the plurality of encoders.

18. The communication system of claim 17, wherein one of the at least two of the plurality of encoders has stronger error protection strength than another of the at least two of the plurality of encoders.

19. The communication system of claim 17, wherein at least two of the plurality of encoders have differing relative levels of error protection strengths.

20. The communication system of claim 17, wherein the transmitter comprises a single interleaver which receives the outputs of at least two of the plurality of encoders.

21. The communication system of claim 17, wherein the plurality of encoders are connected to a plurality of interleavers.

22. The communication system of claim 17, further comprising a receiver comprising a plurality of decoders.

23. A method for communicating, comprising:
parsing bits from at least one data source among a plurality of encoders;
encoding, by the plurality of encoders, the bits;
mapping the encoded bits onto symbols;
mapping symbols onto tones; and
transmitting the tones.

24. The method of claim 23, further comprising interleaving the encoded bits.

25. The method of claim 23, wherein the encoding further comprises encoding some of the bits using a relatively stronger error protection strength encoder and encoding others of the bits using a relatively weaker error protection strength encoder.

26. The method of claim 23, wherein the mapping the encoded bits onto symbols further comprises mapping at least one encoded bit from one of the plurality of encoders onto a symbol and mapping at least one encoded bit from another of the plurality of encoders onto the symbol.

27. The method of claim 23, further comprising:
receiving the tones; and
decoding, by a plurality of decoders, received bits mapped on symbols on the received tones.

28. A communication system, comprising:
short-range receiver comprising a plurality of decoders, the decoders decoding received bits mapped on symbols on received tones, the bits received from at least one transmitter comprising a plurality of encoders and at least one interleaver.

29. The communication system of claim 28, wherein the received bits from one symbol were produced by at least two of the plurality of encoders.

30. The communication system of claim 28, wherein at least one of the encoders has a different error protection strength than at least one other of the encoders.
